(19) United States
(12) Patent Application Publication
(10) Pub. No.: US 2025/0377832 A1
(43) Pub. Date: Dec. 11, 2025

(54) FREEZE COMMAND AND RESTORE COMMAND ASSOCIATED WITH TAGGED CAPACITY FOR A COMPUTE EXPRESS LINK (CXL) MEMORY DEVICE

(71) Applicant: MICRON TECHNOLOGY, INC., Boise, ID (US)

(72) Inventor: John M. Groves, Austin, TX (US)

(21) Appl. No.: 19/211,751

(22) Filed: May 19, 2025

Related U.S. Application Data
(60) Provisional application No. 63/657,201, filed on Jun. 7, 2024.

(51) Int. Cl. G06F 3/06

(52) U.S. Cl. CPC G06F 3/0659; G06F 3/0604; G06F 3/0631; G06F 3/0688

(57) ABSTRACT

A system can include a memory device comprising a plurality of dynamic capacity devices and a processing device, operatively coupled with the memory device. The processing device is configured to perform operations including receiving a host command to freeze first data associated with a first tag, wherein the first tag is associated with a first memory section of a plurality of dynamic capacity devices, and wherein the first memory section is allocated to a first host system to store the first data. The operations further include responsive to receiving the host command to freeze, making the first data inaccessible to the first host system; and responsive to determining that the host command indicates to free the first memory section, storing the first data in a second memory device, wherein the second memory device is not included in the plurality of dynamic capacity devices.

### RELATED APPLICATIONS

This application claims the benefit of U.S. Provisional Patent Application No. 63/657,201, filed Jun. 7, 2024, the entire contents of which are incorporated by reference herein.

### TECHNICAL FIELD

Embodiments of the disclosure relate generally to memory sub-systems, and more specifically, relate to implementing freeze commands and restore commands associated with tagged capacity in a compute express link (CXL) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for using freeze commands and restore commands associated with tagged capacity in a compute express link (CXL) memory device in accordance with some embodiments of the present disclosure.

FIG. 3A illustrates an example of freeze/restore command in accordance with some embodiments of the present disclosure.

FIG. 3B illustrates an example of tag mapping data structure in accordance with some embodiments of the present disclosure.

FIG. 4 is a flow diagram of an example method for using a freeze command associated with tagged capacity in a compute express link (CXL) memory device in accordance with some embodiments of the present disclosure.

FIG. 5 is a flow diagram of an example method for using a restore command associated with tagged capacity in a compute express link (CXL) memory device in accordance with some embodiments of the present disclosure.

FIG. 6 is a block diagram of an example computer system in which embodiments of the present disclosure may operate.

### DETAILED DESCRIPTION

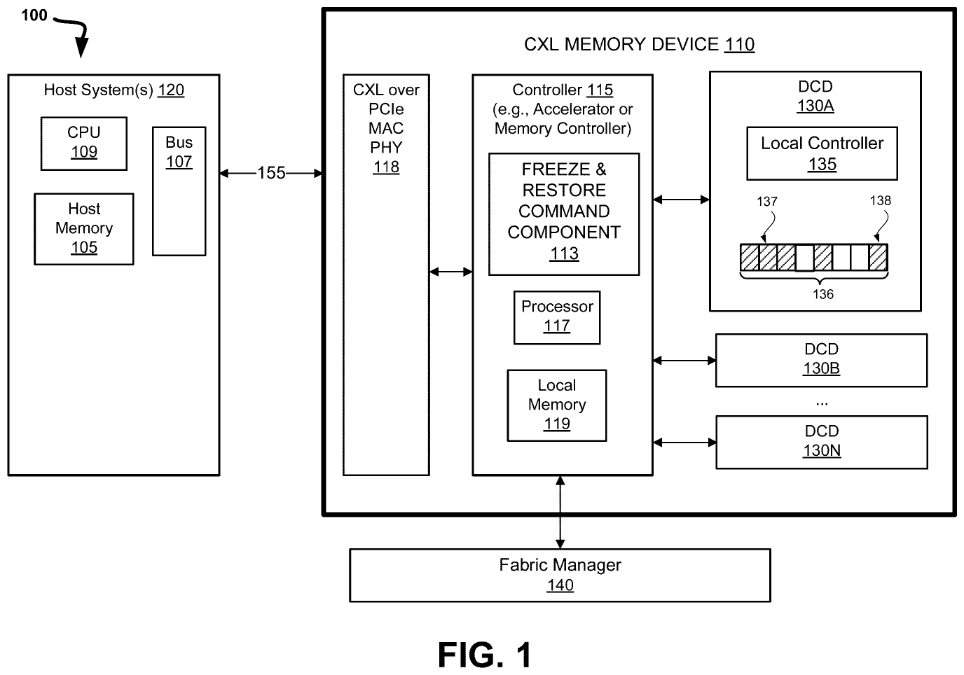

Aspects of the present disclosure are directed to implementing freeze commands and restore commands associated with tagged capacity in a compute express link (CXL) memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A CXL system maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

A memory device that supports CXL protocols and can be attached to a host via CXL is referred to as a CXL memory device, which can provide additional bandwidth and capacity to host processors. The CXL memory device is independent of the host memory. In some implementations, the CXL memory device may partition resources into multiple logical devices, and each logical device can be visible as a memory device. In some implementations, the CXL memory device may support multiple host systems. A fabric manager may configure resource allocation for multiple host systems across the logical devices. Dynamic capacity (DC) is a feature of a CXL memory device that allows exposed memory capacity to be allocated and freed dynamically without the need for resetting the CXL memory device. Although the CXL memory device is used here as an illustrative example for implementing the dynamic capacity, the dynamic capacity feature can be applied to other memory devices.

Specifically, a dynamic capacity device (DCD) is a memory device, such as a CXL memory device, that implements dynamic capacity (DC). The device physical address (DPA) range of a DCD can be subdivided into several regions (e.g., 1 to 8 regions) and each of these regions may be further subdivided into a set of blocks. One or more blocks that can be allocated to a host system and associated with a tag are referred to as a taggable DC unit. The taggable DC unit may represent a management unit that can be tagged, assigned in various capacity size, and dynamically allocated to various host systems. A taggable DC unit that has been assigned with a tag is referred to as a tagged capacity unit. Each tag is globally unique, and thus the tags associated with the taggable DC units can form an aggregate tag space in the memory device, such as the CXL memory device, and each tag in the aggregate tag space is uniquely identifiable. Each tag can be associated with one or more host systems and may be mapped to one or more DPA ranges (e.g., a set of one or more contiguous physical address ranges or physical address extent-lists (i.e., non-contiguous address ranges) that identify respective locations storing the data on the DCDs). Each tag may be shareable or not.

Specifically, the fabric manager controls the allocation of these taggable DC units to one or more host systems (or a group of host systems) and utilizes events to signal the host systems when changes to the allocation of these taggable DC units occurs. The fabric manager also assigns a tag to the allocated taggable DC units by associating, in a tag mapping data structure, the tag with the taggable DC units represented by one or more physical addresses (e.g., one or more DPA ranges). The memory device maps the DPA ranges to the taggable DC units. The tag can thus be referred to as representing the tagged capacity units. The host system can map these DPA ranges to corresponding host physical address (HPA) ranges within the host address space available to the host system. In some implementations, the memory device may communicate the state of these tagged capacity units through an extent list that describes the starting DPA and length of all blocks the host system can access, where the extent list is managed by the memory device. The host system (or fabric manager on behalf of the host system) may use a set of commands for querying and configuring the tagged capacity units. The set of commands may include a command allocating the new tagged capacity units (e.g., Initiate Dynamic Capacity Add command), a command releasing the tagged capacity units (e.g., Initiate Dynamic Capacity Release command), and getting information of the tagged capacity units. The capacity of the sharable tagged capacity units associated with a tag and allocated to a host system is immutable such that no additional capacity can be added to the tag, nor can capacity be deleted from the tag. That is, although the content stored in the tagged capacity units can be modified, the mapping between the tag and the tagged capacity units allocated to the host system cannot be modified through the life of the sharable tag. A host system is thus required to request re-allocation for different capacities of tagged capacity units or for different tags being associated. Further, there is a need to use the tagged capacity units more efficiently, especially when using together with higher-cost volatile memory devices such as dynamic random-access memory (DRAM).

Aspects of the present disclosure address the above and other deficiencies by implementing freeze commands and restore commands associated with tagged capacity in compute express link (CXL) memory devices. A freeze command associated with tagged capacity enables a host system to freeze data stored in a tagged capacity unit associated with a source tag (“data of source tag”), and make the source tag unavailable. The freeze command may further enable the CXL memory device to swap out the frozen data to a backing store such as a non-DCD memory device and free the associated tagged capacity unit so that the memory space can be reallocated to fulfill a request for memory resources. To free the tagged capacity unit, the CXL memory device may disassociate, in a tag mapping data structure, the DPA range with the source tag and mark the DPA range as free to use.

As such, data of source tag cannot be modified when the data is frozen. In some implementations, the frozen data can serve as a checkpoint copy. Although the source tag cannot be changed in the capacity as well as the mapping between the source tag and the tagged capacity units allocated to the host system cannot be modified, the source tag can be considered as being “unavailable” in that the associated tagged capacity units can be released and allocated to other host systems and/or associated with other tags. In some implementations, the host system can select tags for freezing (and swapping out) based on certain heuristics, e.g., based on the access frequency, most recent access time, etc.

The freeze command may specify the source tag and specify whether to free the tagged capacity unit (e.g., the DPA ranges) associated with the source tag. The freeze command may make the source tag unavailable, including making the data of the source tag inaccessible to the host system. In some implementations, making the data of the source tag inaccessible includes setting an item (e.g., a flag) of a tag mapping data structure to a value indicating the DPA ranges associated with the source tag is inaccessible. In some implementations, making the data of the source tag inaccessible includes changing the access permission by hiding the DPA ranges associated with the source tag from the host system. Therefore, the host system that was previously able to access the data of source tag can no longer access the data of the source tag. In response to an attempt to access the source tag, the host system may receive a notification about the frozen tag and/or a recommendation for restoring the data.

A restore command associated with tagged capacity enables a host system to swap in data, of a frozen tag, stored in another memory device to a tagged capacity unit associated with a destination tag (e.g., a new tag or the original source tag). Alternatively, if the data of the frozen tag is still present in the tagged capacity unit associated with the source tag, the restore command associated with tagged capacity enables the host system to make re-available the source tag. Therefore, the frozen data can be brought back to the DCDs and associated with the destination tag.

The restore command may specify a frozen tag and specify the host system that can access (e.g., read, write, etc.) the data of the destination tag. The restore command may further specify a selection policy indicating the policy for selecting the taggable DC unit used for the destination tag. The selection policy can include a “free and contiguous” policy that allows a memory controller to select an available and contiguous taggable DC unit, or a “prescriptive” policy that allows the fabric manager to select the taggable DC unit so that the selection is globally controlled. Therefore, the host system that was previously able to access the data of source tag can access the data again by accessing a particular copy (e.g., by referencing a destination tag) of the original data.

Advantages of the present disclosure include efficient modification of tagged capacity units allocated to a host system by using commands regarding the tags. Specifically, the system significantly improves flexibility in using the tagged capacity. Aspects of the present disclosure enables to use valuable DRAM more efficiently while keeping data sets ready to be re-accessible via the commands associated with the tagged capacity. A copy of data of the frozen tag may also serve as a checkpoint copy, and a meaningful checkpoint copy may constitute several frozen Tags.

FIG. 1 illustrates an example computing system 100 that includes a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory device 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize a CXL interface to access components of the CXL memory device 110 when the CXL memory device 110 is coupled with the host system 120 by the physical host interface (e.g., PCIe bus). FIG. 1 illustrates a CXL memory device 110 as an example. In general, the host system 120 can access multiple CXL memory devices 110 via a same communication connection, multiple separate communication connections, and/or a combination of communication connections.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 may include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 may be a cache-coherent interconnect for processors, memory expansion, and accelerators. The computing system 100 maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use it for memory bandwidth expansion, memory capacity expansion, and persistent memory applications, and as small-scale resource pooling, and large-scale resource pooling and sharing.

In some implementations, the CXL memory device may be a multiple logical device (MLD), which may partition resources into multiple logical devices, and each logical device can be visible as a memory device. One of multiple logical devices can be reserved for a fabric manager to configure resource allocation across the logical devices, while the other logical devices can be available for assigning to the host. In some implementations, the CXL memory device may be a device that supports multiple host systems and may be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control operation of the CXL memory device 110, including handling communications between the CXL memory device 110 and the host system 120. The CXL memory device controller 115 may manage operations of CXL memory device 110, such as writes to and reads from DCD 130A-130N. The CXL memory device controller 115 may include one or more processors 117, which may be multi-core processors. Processors 117 can handle or interact with the components of DCD 130A-130N, generally through firmware code. The CXL memory device controller 115 may operate under CXL protocol, but other protocols are applicable.

The CXL memory device controller 115 executes computer-readable program code (e.g., software or firmware) executable instructions (herein referred to as “instructions”). The instructions may be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 may be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 may interact with DCD 130A-130N for read and write operations. The CXL memory device controller 115 may execute the direct memory access (DMA) for data transfers between host system 120 and DCD 130A-130N without involvement from CPU 109. The CXL memory device controller 115 may control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 or the fabric manager 140 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a raw DCDs 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140. The fabric manager 140 is an external logical process that queries and configures the operational state of the computing system 100, and may include application logic and policy that makes the assignments of DCDs 130A-130N to the host system 120 at run time. In some embodiments, the fabric manager 140 may be software running on the host system 120, firmware embedded within a Baseboard Management Controller (BMC) on another CXL device or a CXL switch, or a dedicated device running in the CXL device. The fabric manager 140 may assign a (logical) device (e.g., DCDs 130A-130N) to the host system 120 by using command sets through the Component Command Interface (CCI). CCI may be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 may assign one taggable DC unit to the host system 120 and create a globally unique tag attached to the taggable DC unit as a tagged capacity unit 137; the fabric manager 140 may assign another taggable DC unit to the host system 120 and create a globally unique tag attached to the taggable DC unit as a tagged capacity unit 138. Although specific number of taggable dynamic capacity units is shown in FIG. 1 and taggable dynamic capacity units shown in FIG. 1 have the same size of capacity, various sizes of capacities can be allocated to the taggable dynamic capacity units according to the request of the host systems, and the number of taggable dynamic capacity units included in a DCD can vary. In some implementations, the capacity size of a taggable dynamic capacity unit may be a multiple of a minimum capacity size, and the minimum capacity size may be 2 MB, 0.5 GB, 1 GB, etc. In some implementations, some or all of the functionality of the fabric manager 140 may be performed by the controller 115 and/or a freeze & restore command component 113.

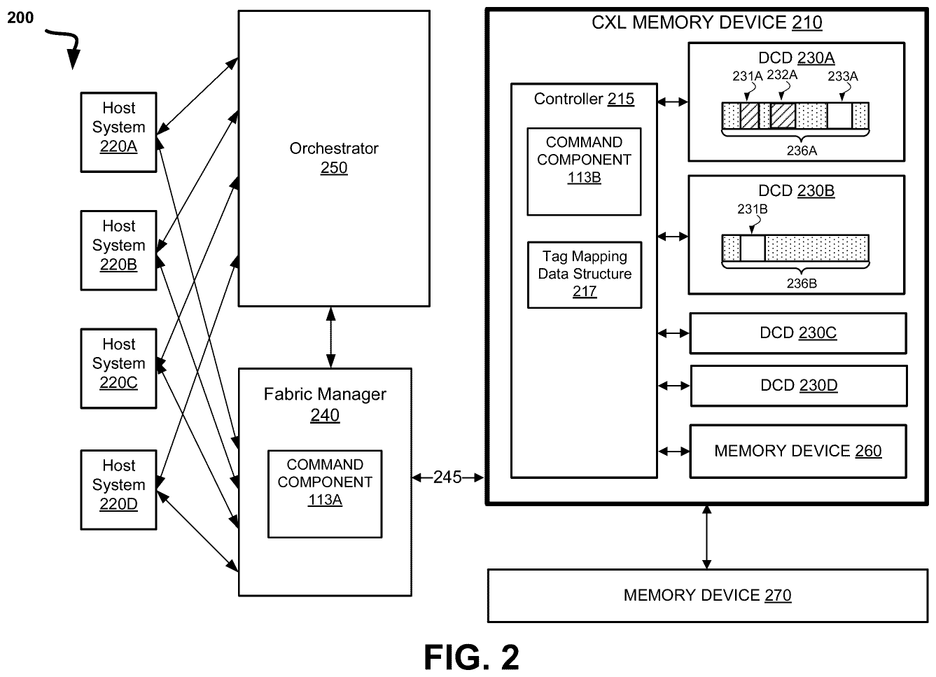

In some embodiments, the CXL memory device 110 includes a freeze & restore command component 113 that enables the host system 120 to perform the freeze command and the restore command. In some embodiments, the freeze command and the restore command each is a mailbox command described above. In some embodiments, the CXL memory device controller 115 includes at least a portion of the freeze & restore command component 113. In some embodiments, the freeze & restore command component 113 is part of the host system 120, an application, or an operating system. In other embodiments, local media controller 135 includes at least a portion of freeze & restore command component 113 and is configured to perform the functionality described herein. Further details regarding the operations of the freeze & restore command component 113 are described below with reference to FIGS. 2-6. In some implementations, freeze & restore command component 113 includes a command component 113A and a command component 113B as shown in FIG. 2, which may operate together to perform the functionality of the freeze & restore command component 113. In some implementations, some or all of the functionalities of the freeze & restore command component 113 may be performed by the fabric manager 240, the controller 215, the command component 113A, the command component 113B, and/or the combination thereof, as shown in FIG. 2.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a schematic block diagram of a system 200 implementing taggable dynamic capacity units in a compute express link (CXL) memory device. In various embodiments, the system 200 includes one or more host systems 220A-D (such as the host system 120), a CXL memory device 210 (such as the CXL memory device 110) that includes a controller 215 (such as controller 115), a CXL fabric interconnect 245, a fabric manager 240 that can perform operations managing the CXL fabric interconnect 245, and an orchestrator 250. In some embodiments, aspects of the controller 215 are included in the processing logic of DCDs 230A-230D. The CXL memory device 210 can be connected to the host systems 220A-D via a network connection interface utilizing the high-speed bus (e.g., a Peripheral Component Interconnect Express (PCIe) bus), such as a compute express link (CXL) fabric interconnect 245. The compute express link (CXL) fabric interconnect 245 may provide an interface that can support several protocols that can run on top of PCIe, including a CXL.io protocol, a CXL.mem protocol, and a CXL.cache protocol. The CXL fabric interconnect 245 may be a collection of one or more switches, and each switch is port based routing (PBR) capable and interconnected with PBR links. The CXL fabric interconnect 245 can connect one or more host ports to the devices within a single coherent host physical address (HPA) space.

In the example of FIG. 2, the DCD 230A may include a first region 236A, and the DCD 230B may include a second region 236B. As shown in FIG. 2, each region of the first region 236A, second region 236B, third region 236C, and fourth region 236D may include one or more taggable dynamic capacity units. Although the regions are illustrated in FIG. 2 as in the uniform size of capacity, the regions can have various capacity sizes.

In some implementations, the orchestrator 250 may control the accessibility to each tag by the host systems 220A-D. The orchestrator 250 may make global control and management decisions about a cluster of the host systems 220A-D. The orchestrator 250 may be responsible for maintaining the desired state (i.e., a state desired by a client when running the cluster) of the host systems 220A-D, such as which applications are running and which container images they use, which resources should be made available for them, and other configuration details. In some implementations, the orchestrator 250 may be a container orchestration system, such as Kubernetes. In some implementations, the orchestrator 250 may be used to provide a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestrator 250 may include nodes to execute applications and/or processes associated with the applications. A “node” providing computing functionality may provide the execution environment for an application. In some implementations, the “node” may include a virtual machine that is hosted on a physical machine, such as the host system 220A-220D implemented as part of the clouds. In some implementations, nodes may additionally or alternatively include a group of virtual machines, a container, or a group of containers to execute functionality of the PaaS applications. When nodes are implemented as virtual machines, they may be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The host systems 220A-D, (e.g., through a node running on the host systems 220A-D), may request allocation of tagged capacity in DCDs 230A-230D. For example, a host system 220A-D, through a node (e.g., an application, a virtual machine) running on the host systems 220A-D, may request of allocation tagged capacity in DCDs 230A-230D, where the request may specify a capacity size.

For initial allocation of tagged capacity, the controller 215 and/or the fabric manager 240 may determine the portions of the DCDs 230A-230D for allocation. In some implementations, the controller 215 may determine an available portion, in the requested capacity size, of the DCDs 230A-230D to be allocated to the host system 220A and request the fabric manager 240 to provide a tag. The controller 215 may receive the tag from the fabric manager 240 and assign the tag to the allocated portion referred to as the tagged capacity unit, for example, the tagged capacity unit 231A or 232A. In some implementations, the fabric manager 240 may determine an available portion, in the requested capacity size, of the DCDs 230A-230D to be allocated to the host system 220A and assign a tag to the allocated portion referred to as the tagged capacity unit, for example, the tagged capacity unit 231A or 232A. In various implementations, the tag is created by the fabric manager 240 so that the tag is globally unique. The controller 215 may store, in the tag mapping data structure 217, the tag, the DPA ranges of the allocated portions of the DCDs 230A-230D, and the host identifier (or a host group identifier) that defines the host system(s) that can access the tag.

Upon the initial allocation of the tagged capacity unit, the host system 220A-220D may write data to the tagged capacity unit. Using the host system 220A and the DCD 230A as an example, upon the initial allocation of the tagged capacity unit 231A or 232A to the host system 220A, the controller 215 may receive, from host system 220A, data created by an application running on the host system 220A. The data can include content that is reflective of a state of the application (e.g., the data can include information that represents the values of the variables, the memory layout, the position of the instruction pointer, and other details about the state of the application). The controller 215 may store the data in the tagged capacity unit 231A or 232A. The controller 215 can write the data to the tagged capacity unit 231A or 232A and map the one or more DPA ranges identifying respective locations containing the data on the CXL memory device 210 with corresponding virtual address ranges in the virtual address space available to the host system 220A (i.e., the virtual/logical address space allocated by a host system to the host application that created the data). As such, the controller 215 can record the data at respective locations identified by a set of corresponding address ranges (e.g., contiguous physical address range or extent list of non-contiguous physical address ranges indicating the locations on the CXL memory device 210 of the data). An example of using the tagged capacity unit 231A or 232A as a source tag for a freeze command and a restore command will be illustrated below with respect to FIG. 2.

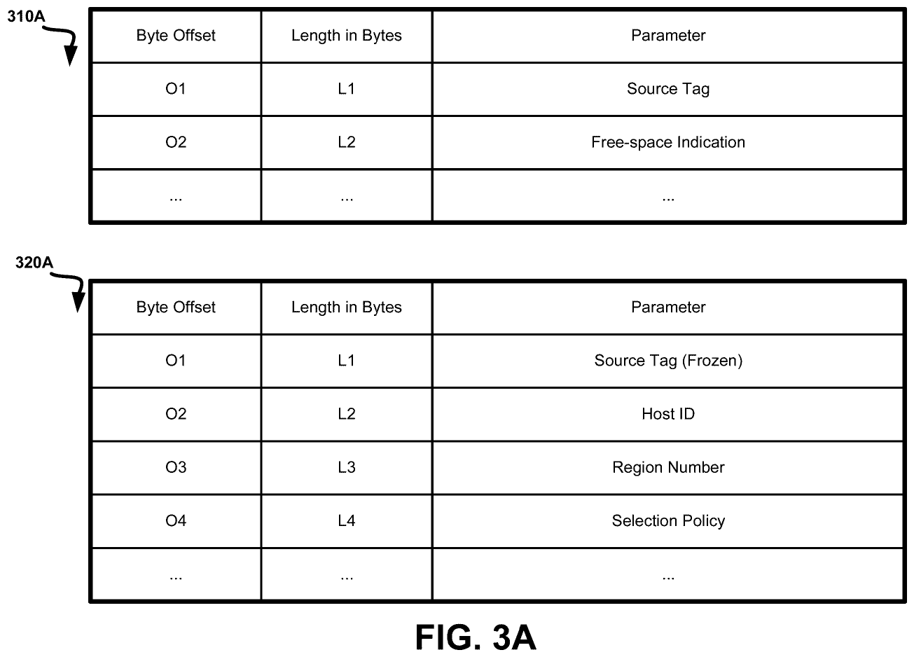

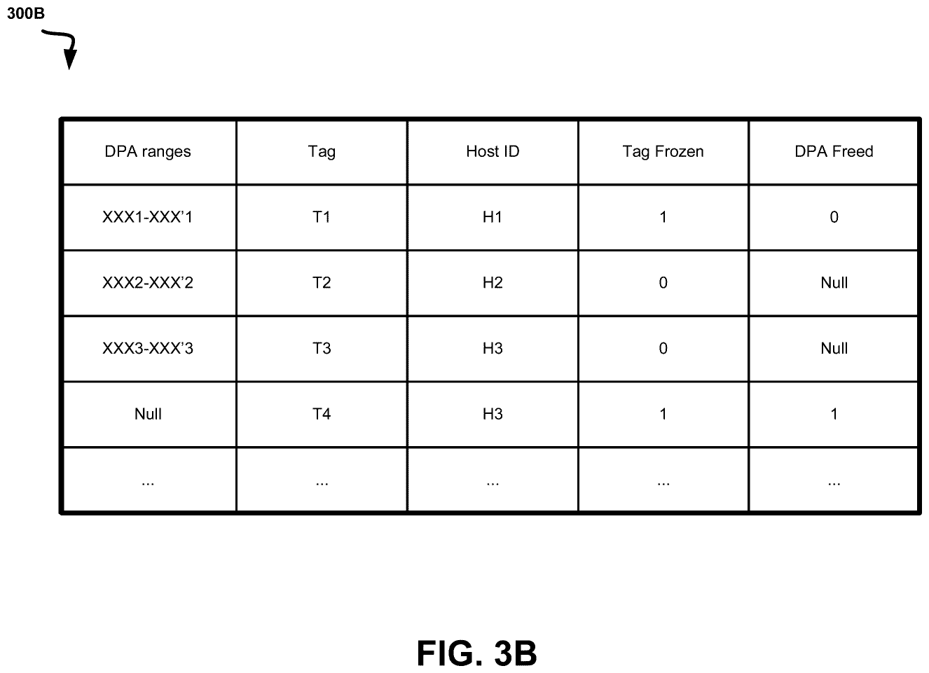

FIG. 3A illustrates an example of a freeze command 310A and an example of a restore command 320A. The freeze command 310A may include bytes designated to represent parameters including a source tag, a free-space indicator, etc. Each parameter of the freeze command may have specific length in bytes and be placed at a specific byte offset. The source tag of the freeze command may identify a tag, where the data associated with the tag is to be frozen such that the data cannot be accessed by the allocated host system. The free-space indicator of the freeze command may define whether the tagged capacity unit (e.g., corresponding to a DPA range) associated with the source tag is to be freed so that the free memory space can be used for other purposes. Although not shown FIG. 3A, the freeze command may include bytes designated to represent parameters including an identifier of a memory device.

The restore command 320A may include bytes designated to represent parameters including a source (frozen) tag, a host identifier (or a host group identifier), a region number, a selection policy, etc. In some implementations, the restore command may further include a destination tag (not shown). Each parameter of the restore command may have specific length in bytes and be placed at a specific byte offset. The source tag of the restore command may identify a tag, where the data associated with the tag is frozen and to be restored in a tagged capacity unit associated with a destination tag. The host identifier (or a host group identifier) of the restore command may identify the host system(s) to which the destination tag of the restore command is to be assigned. The region number of the restore command may identify the region of the DCDs in which the tagged capacity unit associated with a destination tag is, where the identified region has various attributes, including whether the region is writable and/or readable, whether the region has the hardware managed coherency that the most recent copy from a cache line is coherent in the hardware, or whether the region is sharable by one or more host systems. The selection policy of the restore command may specify the policy for selecting the taggable DC unit of the DCDs as the tagged capacity unit associated with a destination tag. For example, a “free and contiguous” policy may allow a memory controller (e.g., controller 215) to select a free and contiguous space in the DCDs, while a “prescriptive” policy may allow a fabric manager (e.g., the fabric manager 240) to select a prescriptive space in the DCDs, The restore command may optionally include bytes designated to represent parameters including the capacity size of the taggable DC unit associated with the destination tag, the number of the taggable DC unit associated with the designation tag, etc. Although not shown FIG. 3A, the restore command may include bytes designated to represent parameters including whether a new tag is to be assigned as the destination tag.

FIG. 3B illustrates an example tag mapping data structure 300B (such as the tag mapping data structure 217) that can be used to implement the freeze command and the restore command. The tag mapping data structure 300B may include an item “DPA ranges,” an item “tag,” and an item “host ID.” The item “DPA ranges” indicates the locations (i.e., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “tag” indicates the tag associated with the tagged capacity unit. The item “host ID” indicates the host system from which the tagged capacity unit associated with the tag can be accessed. The mapping data structure 300B may include multiple records, and each record may correspond to a tag, and each record includes multiple items described here.

The tag mapping data structure 300B may further include an item “tag frozen” indicating whether the tag is frozen or not, i.e., whether the tag is available or not. The tag mapping data structure 300B may further include an item “DPA freed” indicating, for a frozen tag, whether the DPA ranges associated with the frozen tag are freed or not.

In view of the item “DPA ranges,” an item “tag,” an item “host ID,” the tag mapping data structure 300B can be used to map the DPA ranges to the host system by mapping the physical address ranges of the tag to corresponding virtual address ranges in a virtual address space of the host system (i.e., the virtual/logical address space allocated by a host system to a host application that is permitted to access the data).

In view of the item “tag frozen” and an item “DPA freed,” the tag mapping data structure 300B can be used to determine whether the tag is frozen and whether the tag that is frozen is freed for other use, respectively. In some implementations, if a frozen tag is freed, the corresponding DPA ranges may be erased as “null” so that a host system cannot use the tag to access the previous DPA ranges. In some implementations, if a frozen tag is freed, the corresponding DPA ranges may be replaced with a memory address of a non-DCD memory device so that a host system can use the memory address of the non-DCD memory device for data of a frozen tag.

In some implementations, the tag mapping data structure 300B may include an item “memory address” representing a location of non-DCD memory device that is used to store the data of a frozen tag. In some implementations, instead of using the item “memory address,” the item “DPA ranges” is used to store the location of non-DCD memory device.

Now referring again to FIG. 2, the implementation of the freeze command and the implementation of the restore command each is illustrated as an example using the host systems 220A and 220B and the DCDs 230A and 230B. It is noted that each of the freeze command and the restore command can be implemented by one or more host systems, one or more nodes, and one or more DCDs. For example, the host system associated with a source tag may or may not be the same as the host system that issues the freeze command; the host system that is previously associated with a source (now frozen) tag may or may not be the same as the host system that issues the restore command. In some implementations, the source tag is not sharable, and in such cases, the host system associated with the source tag is the same host system as that issues the restore command. In some implementations, the destination tag is sharable only if the source tag is sharable. In some implementations, the command component 113A included in the fabric manager 240 and the command component 113B included in the controller 215 may perform the functions of the freeze & restore command component 113 of FIG. 1, and operate together to implement the freeze command and/or restore command.

To implement the freeze command, the host system 220B may send, through the node (e.g., an application, a virtual machine) running on the host system 220B, a freeze command to the CXL memory device 210. The freeze command may enable the host system 220B to make the source tag unavailable by freezing the data stored in a tagged capacity unit with a source tag so that the data is inaccessible to the host system 220B. Freezing the data may involve disabling an access to the data by setting an item (e.g., a flag such as the item “tag frozen” in FIG. 3B) of a tag mapping data structure (e.g., tag mapping data structure 300B in FIG. 3B) to a value (e.g., a predefined value) indicating the DPA ranges associated with the source tag is inaccessible or making the DPA ranges of the source tag hidden from the host system 220B. The freeze command may further enable the controller 215 to swap out the frozen data in another memory device (e.g., memory device 260, 270) and free the tagged capacity unit (e.g., the DPA ranges) associated with the source tag. Freeing the tagged capacity unit involves disassociating the DPA ranges with the source tag and mark the DPA ranges as free to use.

For example, the host system 220B may send a freeze command, where the freeze command includes a first source tag 231A and a first free-space indicator. For example, the first source tag 231A may be associated with the host system 220A. Responsive to determining that the first free-space indicator instructs to not free the memory space, i.e., to keep the data of the first source tag 231A as it is in the DCD 230A, the command component 113B may make the first source tag 231A inaccessible without additional actions. As another example, the host system 220B may send a freeze command, where the freeze command includes a second source tag 232A and a second free-space indicator. Responsive to determining that the second free-space indicator instructs to free the memory space, i.e., to move the data of the second source tag 232A to another memory device and disassociate the memory addresses, the command component 113B may determine the memory device 260 in the CXL memory device 210 as the destination for the data movement. The command component 113B may search a free memory space in the memory device 260, and upon finding a free memory space that fits the size of the data of the second source tag 232A, store the data of the second source tag 232A in the memory device 260. In some implementations, the command component 113B may not find enough memory space in the memory device 260 for data movement, and may then determine the memory device 270 that is external to the CXL memory device 210 as the destination for data movement. The command component 113B may communicate with a local controller in the memory device 270 to search a free memory space in the memory device 270, and upon finding a free memory space that fits the size of the data of the second source tag 232A, send the data of the second source tag 232A to the memory device 270. After the data of the second source tag 232A has been stored in the memory device 260 or 270, the command component 113B may free the tagged capacity unit associated with the second source tag 232A. The command component 113B may update the tag mapping data structure 217 by modifying the record of the second source tag 232A. The command component 113B may notify the host system 220B regarding the completion of the freeze command.

To implement the restore command, the host system 220C may send, through the node (e.g., an application, a virtual machine) running on the host system 220C, a restore command to the CXL memory device 210. The restore command may enable the host system 220C to swap in data, of a frozen tag, stored in a non-DCD memory device (e.g., the memory device 260 or 270) to a tagged capacity unit associated with a destination tag so that the data is put back and can be given a full access to the host system 220C.

For example, the host system 220C may send a restore command, where the restore command includes a source (frozen) tag 231A, a host identifier (or a host group identifier) 220C, and a selection policy as “free and contiguous.” The command component 113B may use the source (frozen) tag 231A to determine whether the memory space associated with the source tag 231A has been freed, for example, by identifying the “DPA freed” item of tag mapping data structure 217. Responsive to determining that the memory space has been freed, which means that the data has been swapped out, the command component 113 may start a process to swap in the data. Responsive to determining that the selection policy is “free and contiguous,” the command component 113B may determine a taggable DC unit in the region 233A (e.g., same region as the source tag), and send a request for a tag to the command component 113A. In response to the tag request, the command component 113A may send the tag to the command component 113B. The command component 113B may assign the tag to the determined taggable DC unit as the tagged capacity unit 233A. The command component 113B may use an item in the tag mapping data structure 217 (e.g., memory address mapped to the source tag 231A) to find the data stored in the memory device 260 or 270 and then retrieve the data and store it in the tagged capacity unit 233A. The command component 113B may update the tag mapping data structure 217 to include a record of the destination tag associated with the tagged capacity unit 233A. The command component 113B may notify the host system 220C regarding the completion of the restore command.

As another example, the host system 220C may send a restore command, where the restore command includes a source tag 231A, a host identifier (or a host group identifier) 220C, a region number 236B, and a selection policy as “prescriptive”. The command component 113B may use the source (frozen) tag 231A to determine whether the memory space associated with the source tag 231A has been freed, for example, by identifying the “DPA freed” item of tag mapping data structure 217. Responsive to determining that the memory space has been freed, which means that the data has been swapped out, the command component 113 may start a process to swap in the data. Responsive to determining that the selection policy is “prescriptive,” the command component 113A may determine a taggable DC unit in the region 236B, and send a tag with information of the determined taggable DC unit to the command component 113B. The command component 113B may assign the tag to the determined taggable DC unit as the tagged capacity unit 231B. The command component 113B may use an item in the tag mapping data structure 217 (e.g., memory address mapped to the source tag 231A) to find the data stored in the memory device 260 or 270 and then retrieve the data and store it in the tagged capacity unit 231B. The command component 113B may update the tag mapping data structure 217 to include a record of the destination tag associated with the tagged capacity unit 231B. The command component 113B may notify the host system 220C regarding the completion of the restore command.

As another example, the host system 220C may send a restore command, where the restore command includes a source tag 231B, and a host identifier (or a host group identifier) 220C. The command component 113B may use the source (frozen) tag 231B to determine whether the memory space associated with the source tag 231B has been freed, for example, by identifying the “DPA freed” item of tag mapping data structure 217. Responsive to determining that the memory space has not been freed, which means that the data has not been swapped out, the command component 113 may make the source tag 231B accessible by the host system 220C, which may serve as a notification of the tag becoming available.

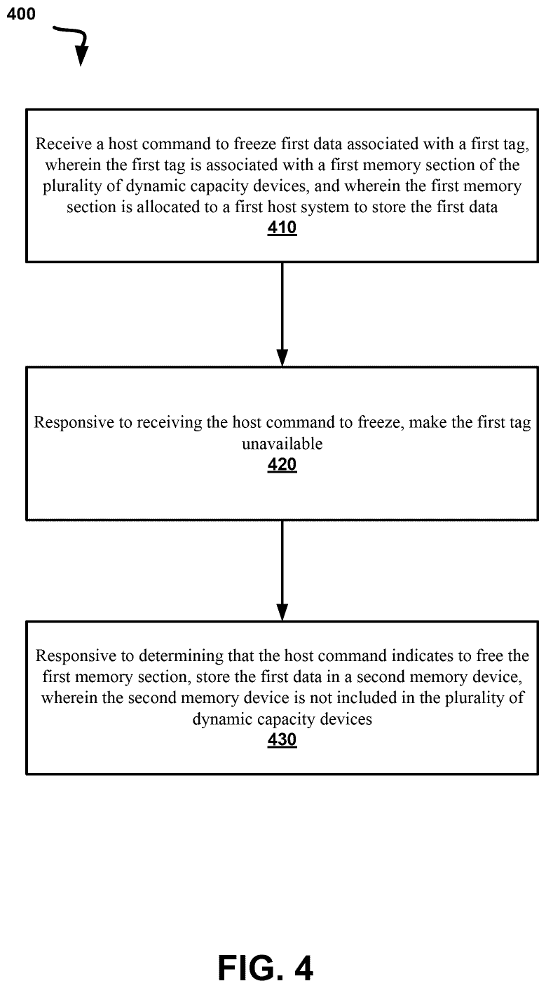

FIG. 4 is a flow diagram of an example method 400 for using a freeze command associated with tagged capacity in a compute express link (CXL) memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the freeze & restore command component 113 of FIG. 1 or the controller 215 (including the command component 113B) and the fabric manager 240 (including the command component 113A) of FIG. 2. In some embodiments, the command to freeze is issued by the fabric manager 240 on behalf of the host system(s). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic can receive a host command to freeze first data associated with a first tag, where the first tag is associated with a first memory section (e.g., memory section corresponding to 231A or 232A) of a plurality of dynamic capacity devices (e.g., DCD 230A-230D) of a memory device (e.g., the CXL memory device 210), and wherein the first memory section is allocated to a first host system to store the first data. In some implementations, each of the plurality of dynamic capacity devices comprises a plurality of memory sections, wherein each of the plurality of memory sections is associated with a respective one of a plurality of tags, and wherein each of the plurality of tags is unique. In some implementations, the host command to freeze specifies the first tag and whether to free the first memory section. In some implementations, the memory device comprises a compute express link (CXL) enabled memory device.

In some implementations, the processing logic can receive an allocation request from the first host system, where the allocation request specifies a first host system and a capacity, allocate the first memory section to the first host system, and associate the first tag with the first memory section. In some implementations, the processing logic can receive the first data from the host system and store the first data in the first memory section. In some implementations, the processing logic can create the first tag responsive to receiving an allocation request by a node in an orchestrator cluster, wherein the node runs on the first host system.

In some implementations, the processing logic can receive an allocation request from the first host system, where the allocation request specifies a first host system and a capacity, allocate the second memory section to the first host system, and associate the second tag with the second memory section. In some implementations, the processing logic can create the second tag responsive to receiving an allocation request by a node in an orchestrator cluster, wherein the node runs on the first host system.

In some implementations, the processing logic can map the first tag to the first memory section and the first host system. In some implementations, the first tag is shared by the first host system and another host system. In some implementations, the capacity of the first memory section allocated to the first host system and associated with the first tag is immutable.

At operation 420, responsive to receiving the host command to freeze, the processing logic can make the data of the source tag inaccessible to the host system. In some implementations, making the data of the source tag inaccessible includes setting an item (e.g., a flag) of a tag mapping data structure to a value indicating the DPA ranges associated with the source tag is inaccessible. In some implementations, making the data of the source tag inaccessible includes changing the access permission by hiding the DPA ranges associated with the source tag from the host system.

In some implementations, responsive to receiving the host command to freeze, the processing logic can determine whether the host command indicates to free the first memory section. In some implementations, the host command indicates to free the first memory section by using a flag bit included in the host command.

At operation 430, responsive to determining that the host command indicates to free the first memory section, the processing logic can store the first data in a second memory device (e.g., the memory device 260, 270), where the second memory device is not included in the plurality of dynamic capacity devices. In some implementations, the second memory device is included in the memory device that includes the plurality of dynamic capacity devices. In some implementations, the second memory device is not included in the memory device that includes the plurality of dynamic capacity devices. In some implementations, the processing logic can store the first data in the second memory device and store, in the metadata of the first data, the first tag with the first data in the second memory device.

In some implementations, the processing logic can determine the second memory device by sending a request, to the second memory device, for a free memory space with a specific size, where the specific size includes the size of the first data, and upon receiving an indication, from the second memory device, that a free memory space with the specific size is available. In some implementations, the processing logic can determine the second memory device by broadcasting a request, to a set of memory devices, for a free memory space with a specific size, where the specific size includes the size of the first data, and upon receiving an indication, from the second memory device, that a free memory space with the specific size is available.

In some implementations, responsive to determining that the host command indicates to free the first memory section, the processing logic can free the first memory section. The processing logic can disassociate the memory addresses (e.g., DPA ranges) of the first memory section with the first tag. The processing logic can disassociate the memory addresses (e.g., DPA ranges) of the first memory section, in a tag mapping data structure, with the first tag.

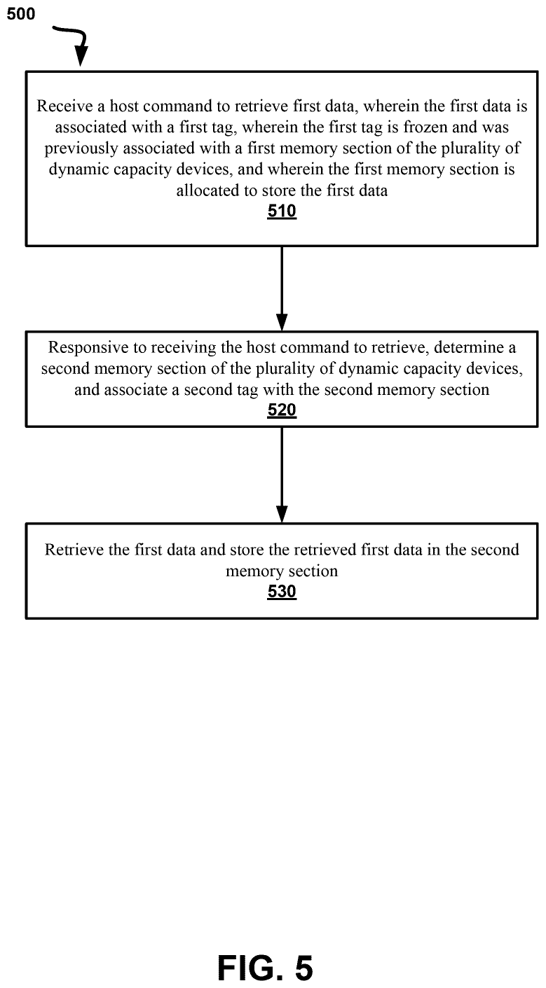

FIG. 5 is a flow diagram of an example method 500 for using a restore command associated with tagged capacity in a compute express link (CXL) memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the freeze & restore command component 113 of FIG. 1 or the controller 215 (including the command component 113B) and the fabric manager 240 (including the command component 113A) of FIG. 2. In some embodiments, the command to retrieve is issued by the fabric manager 240 on behalf of the host system(s). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic can receive a host command to retrieve first data, wherein the first data is associated with a first tag, wherein the first tag is frozen and was previously associated with a first memory section (e.g., memory section corresponding to 231A or 232A) of a plurality of dynamic capacity devices (e.g., DCD 230A-230D) of a memory device (e.g., the CXL memory device 210), and wherein the first memory section is allocated to store the first data. In some implementations, each of the plurality of dynamic capacity devices comprises a plurality of memory sections, wherein each of the plurality of memory sections is associated with a respective one of a plurality of tags, and wherein each of the plurality of tags is unique.

In some implementations, the first data is stored in a second memory device (e.g., the memory device 260, 270). The second memory device is a non-DCD memory device. The second memory device is not included in the plurality of dynamic capacity devices. In some implementations, the second memory device is included in the memory device that includes the plurality of dynamic capacity devices. In some implementations, the second memory device is not included in the memory device that includes the plurality of dynamic capacity devices.

In some implementations, the first data is stored in the first memory section (e.g., memory section corresponding to 231A or 232A), and to retrieve the first data, the processing device can make the first tag available.

In some implementations, the host command to retrieve specifies the first tag. In some implementations, the host command to retrieve specifies an identifier of the host system. In some implementations, the host command to retrieve specifies at least one of: a region identifier of the memory device, or a selection policy for selecting a memory section. In some implementations, the memory device comprises a compute express link (CXL) enabled memory device.

At operation 520, responsive to receiving the host command to retrieve, the processing logic can determine a second memory section (e.g., memory section corresponding to 233A or 231B) of the plurality of dynamic capacity devices, and associate a second tag with the second memory section.

In some implementations, the host command to retrieve is received from a second host system, and wherein the host command specifies the second host system. In some implementations, the processing logic can map the second tag to the second memory section and the second host system. In some implementations, the second tag is shared by the second host system and another host system. In some implementations, the capacity of the second memory section allocated to the second host system and associated with the second tag is immutable.

At operation 530, the processing logic can retrieve the first data and store the retrieved first data in the second memory section. In some implementations, the processing logic can determine whether the first data has been moved to a second memory device. In some implementations, the processing logic can determine whether the first data has been moved to a second memory device.

In some implementations, the processing logic can use the first tag to determine whether the first memory section has been freed by identifying the “DPA freed” item of tag mapping data structure. Responsive to determining that the first memory section has been freed, which means the data has been swapped out, the processing logic can use the an item (e.g., “memory address” item) in the tag mapping data structure (e.g., memory address mapped to the source tag 231A or 232A) to find the data stored in the second memory device (e.g., the memory device 260, 270) and then retrieve the data and store it in the second memory section (e.g., memory section corresponding to 233A or 231B).

Responsive to determining that the first memory section has not been freed, which means the data has not been swapped out, the processing logic can make the first tag available, for example, in the tag mapping data structure, retrieve the data stored in the first memory section (e.g., memory section corresponding to 231A or 232A) associated with the first tag and store it in the second memory section (e.g., memory section corresponding to 233A or 231B).

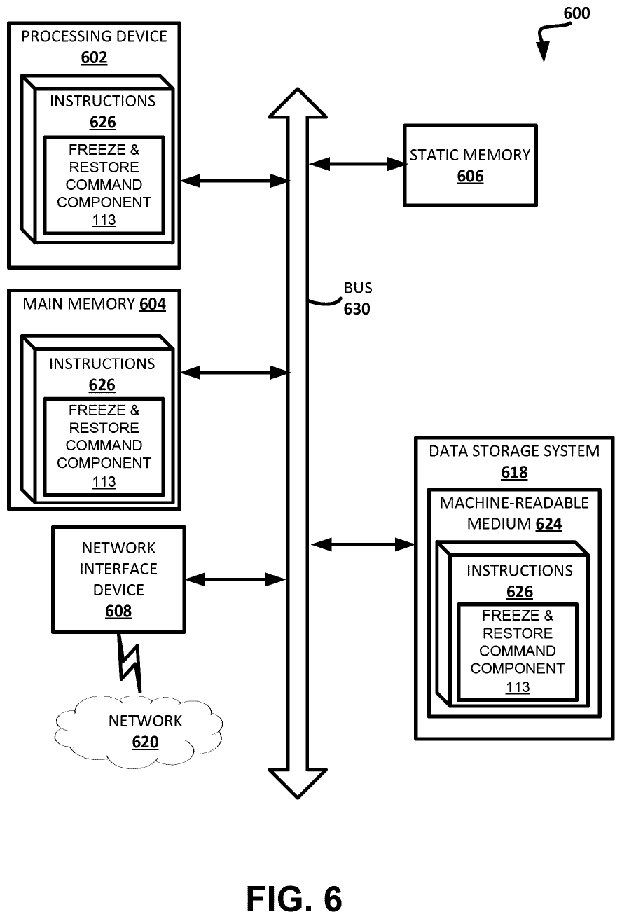

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the CXL memory device 110 of FIG. 1) or can be used to perform the operations of a controller (e.g., to execute an operating system to perform operations corresponding to the freeze & restore command component 113 of FIG. 1 or the controller 215 (including the command component 113B) and the fabric manager 240 (including the command component 113A) of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the CXL memory device 110 of FIG. 1.

In one embodiment, the instructions 626 include instructions to implement functionality corresponding to an APL management component (e.g., the freeze & restore command component 113 of FIG. 1 or the controller 215 (including the command component 113B) and the fabric manager 240 (including the command component 113A) of FIG. 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a plurality of dynamic capacity devices; and
a processing device, operatively coupled with the memory device, to perform operations comprising:
receiving a host command to freeze first data associated with a first tag, wherein the first tag is associated with a first memory section of the plurality of dynamic capacity devices, and wherein the first memory section is allocated to a first host system to store the first data;
responsive to receiving the host command to freeze, making the first data inaccessible to the first host system; and
responsive to determining that the host command indicates to free the first memory section, storing the first data in a second memory device, wherein the second memory device is not included in the plurality of dynamic capacity devices.

2. The system of claim 1, wherein each of the plurality of dynamic capacity devices comprises a plurality of memory sections, wherein each of the plurality of memory sections is associated with a respective one of a plurality of tags, and wherein each of the plurality of tags is unique.

3. The system of claim 1, wherein the host command specifies the first tag.

4. The system of claim 1, wherein the host command specifies whether to free the first memory section.

5. The system of claim 1, wherein the operations further comprise:
responsive to determining that the host command indicates to free the first memory section, disassociating the first tag with the first memory section.

6. The system of claim 1, wherein a capacity of the first memory section allocated to the first host system and associated with the first flag is immutable.

7. The system of claim 1, wherein making the first data inaccessible comprises setting an item of a tag mapping data structure to a predefined value.

8. The system of claim 1, wherein the memory device comprises a compute express link (CXL) enabled memory device.

9. The system of claim 1, wherein the operations further comprise:
responsive to receiving a first allocation request from the first host system, determining the first memory section and associating the first tag with the first memory section; and
storing the first data in the first memory section.

10. The system of claim 9, wherein the operations further comprise:
creating the first tag responsive to receiving the first allocation request by a first node in an orchestrator cluster, wherein the first node runs on the first host system.

11. The system of claim 1, wherein the operations further comprise:
responsive to determining that the host command indicates to free the first memory section, determining the second memory device.

12. A method comprising:
receiving, by a processing device, a host command to freeze first data associated with a first tag, wherein the first tag is associated with a first memory section of a plurality of dynamic capacity devices of a memory device, and wherein the first memory section is allocated to a first host system to store the first data;
responsive to receiving the host command to freeze, making the first data inaccessible to the first host system; and
responsive to determining that the host command indicates to free the first memory section, storing the first data in a second memory device, wherein the second memory device is not included in the plurality of dynamic capacity devices.

13. The method of claim 12, wherein each of the plurality of dynamic capacity devices comprises a plurality of memory sections, wherein each of the plurality of memory sections is associated with a respective one of a plurality of tags, and wherein each of the plurality of tags is unique.

14. The method of claim 12, wherein the host command specifies the first tag.

15. The method of claim 12, wherein the host command specifies whether to free the first memory section.

16. The method of claim 12, further comprising:
responsive to determining that the host command indicates to free the first memory section, disassociating the first tag with the first memory section.

17. The method of claim 12, wherein a capacity of the first memory section allocated to the first host system and associated with the first flag is immutable.

18. The method of claim 12, wherein making the first data inaccessible comprises setting an item of a tag mapping data structure to a predefined value.

19. The method of claim 12, further comprising:
responsive to determining that the host command indicates to free the first memory section, determining the second memory device.

20. A non-transitory computer-readable storage medium comprising instructions that, when executed by a processing device, cause the processing device to perform operations comprising:
receiving a host command to freeze first data associated with a first tag, wherein the first tag is associated with a first memory section of a plurality of dynamic capacity devices, and wherein the first memory section is allocated to a first host system to store the first data;
responsive to receiving the host command to freeze, making the first data inaccessible to the first host system; and
responsive to determining that the host command indicates to free the first memory section, storing the first data in a second memory device, wherein the second memory device is not included in the plurality of dynamic capacity devices.
